(19) United States
(12) Patent Application Publication
(10) Pub. No.: US 2011/0266993 A1
(43) Pub. Date: Nov. 3, 2011

(54) Systems and methods for solar based battery charging

(76) Inventor: Himangshu Rai Vaish, New Delhi (IN)

(21) Appl. No.: 13/128,268

(22) PCT Filed: Nov. 9, 2009
(86) PCT No.: PCT/IN09/00630

§ 371 Date: Jul. 18, 2011

(30) Foreign Application Priority Data
Nov. 10, 2008 (IN) 2545/DEL/2008

(51) Int. Cl. H01M 10/46

(52) U.S. Cl. 320/101

(57) ABSTRACT

The present invention relates to systems and methods for solar based battery charging for use in systems positioned remotely or susceptible to discontinuous power supply such as solar powered aviation obstruction lights. In an embodiment, a solar powered aviation obstruction light includes a solar panel (102), a battery system (106), a controller (108), and a LED cluster (110). The solar panel (102) energizes one or more batteries of the battery system (106), wherein the one or more batteries to be charged are selected based on an indication given by the controller (108), further wherein the indication given by the controller is based on the remaining battery voltage level in the discharging mode. The battery with the highest remaining voltage level can be used first for lighting the LED cluster (110) during the night and the other batteries can be sequentially used such that usage of all batteries can be rotated to lengthen the lifespan of the battery system (106).

### FIELD OF INVENTION:

The present invention relates to systems and methods for solar based battery charging for use in systems positioned remotely or susceptible to discontinuous power supply such as solar powered aviation obstruction lights, making such systems cost effective, environment friendly, and reliable through self-diagnostic and fault reporting mechanisms.

### BACKGROUND OF THE INVENTION

Over the years various products using solar panels like aviation warning lights have been made using various light sources including LEDs. A large number of such lights are installed on towers, high rise structures, buildings, TV Towers among such other locations where there is a high cost of cabling, labor, and need of AC and/or DC power. With a view to optimize the cost and take advantage of using renewable sources of energy, solar panel based lights were also developed. Such lights when made with inbuilt solar panels had lower efficiency due to the varying requirement of angle at which the solar panels need to be mounted at multiple latitudes for optimum results. Also the size of the panel could vary depending on the autonomy required. Moreover, there is a need to maximize the uptime depending upon the solar insolation received from time to time and the time required for replacement of batteries. The batteries are sized keeping cloudy days and consequent autonomy in mind. However, when single battery or multiple battery in series are used, everyday the batteries are partially discharged and recharged resulting in the battery going through the charge discharge cycle which determines its life. To get the best life from the batteries the battery required should be selected based on the ampere-hours required for a single day of operation and have multiple batteries in parallel to take care of the autonomy required. This would also possibly result in selection of a smaller solar panel and consequently savings in capital and recurring operating expenditure.

Therefore to take care of above discussed issues, a solar based charge/discharge system for the batteries is required to take care of systems to overcome the drawbacks of the existing systems in a cost effective and environment friendly manner with self-diagnosis and remote fault reporting facility. A typical example discussed is a solar powered aviation obstruction light. Many remote warning systems and remote data collection devices for environmental parameters also depend upon similar solar systems.

### OBJECT OF THE INVENTION

It is an object of the invention to provide solar based battery charging that allows for a reduction in solar panel size and further ensures charging of at least one battery of a battery system in the shortest possible period.

It is an object of the invention to provide solar based battery charging for use in systems positioned remotely or susceptible to discontinuous power supply such as aviation obstruction lights.

It is an object of the invention to provide solar based battery charging that ensures battery working even during periods of low sun intensity or during periods when sun is available intermittently or for a short period

It is an object of the invention to provide solar based battery charging for use in systems, positioned remotely or susceptible to discontinuous power supply, which are cost effective and environment friendly.

It is an object of the invention to provide solar based battery charging for use in systems with self-diagnostic features configured to effectively communicate partial failure of such systems.

It is another object of the invention to provide solar based battery charging that enables an efficient use of battery system thereby increasing its availability and life.

It is another object of the invention to provide solar based battery charging for use in systems that enable saving of length/cost of the wires used to electrify the conventional systems.

It is another object of the invention to provide solar based battery charging for use in systems that enable saving the regular labor and maintenance expenses during and after installation of the system.

### SUMMARY

The present invention relates to systems and methods for battery charging for use in systems where the batteries are normally not fully discharged on a daily basis. The system proposed is especially suitable for products positioned remotely or susceptible to discontinuous power supply such as solar powered aviation obstruction lights, making such systems cost effective, environment friendly, and reliable through self-diagnostic and fault reporting mechanisms. In an embodiment, a solar powered aviation obstruction light, also referred to as an aviation obstruction light hereinafter, includes a solar panel, a battery system, a controller, and a LED cluster. The solar panel energizes one or more batteries of the battery system, wherein the one or more batteries to be charged are selected based on an indication given by the controller considering the optimal performance of the system and life of the batteries, further wherein the indication given by the controller is based on the remaining battery voltage level in the discharging mode. The battery life is enhanced if it is discharged after being charged fully. The battery with the highest remaining voltage level can be used first for lighting the LED cluster during the night or during periods with low light and/or visibility and the other batteries can be sequentially used such that usage of all batteries can be rotated to lengthen the lifespan of the battery system.

It is to be noted that even though the description of the systems and the methods is described using aviation obstruction lights, it should not, in any manner, be construed to restrict the application of the solar based battery charging solely to such systems and/or devices. The solar based battery charging can be applied to all conventional battery enabled systems and particularly to systems that are positioned remotely or are susceptible to discontinuous power supply.

### BRIEF DESCRIPTION OF THE DRAWINGS

The detailed description is set forth with reference , to the accompanying figures. In the figures, the left-most digit(s) of a reference number identifies the figure in which the reference number first appears. The use of the same reference numbers in different figures indicates similar or identical items.

FIG. 1 illustrates block diagram of a solar based battery charging system.

FIG. 2 illustrates structural layout of a solar based battery charging system.

FIG. 3 illustrates an exemplary method showing working of a solar based battery charging system.

### DETAILED DESCRIPTION

Multiple and varied implementations and embodiments are described below. After this discussion, representative implementations of systems, devices, and methods for providing aviation obstruction lights are described.

Although, the present invention is described in connection with exemplary embodiments, the invention not intended to be limited to the specific forms set forth herein. On the contrary, it is intended to cover such alternatives, modifications, and equivalents as can be reasonably included within the scope of the invention.

In the following description, for purposes of explanation, numerous specific details are set forth in order to provide a thorough understanding of the present invention. It will be apparent, however, to one skilled in the art that the present invention may be practiced without these specific details.

As used herein, the terms “a” and “an” do not denote a limitation of quantity, but rather denote the presence of at least one of the referenced item.

It is to be noted that even though the description of the systems and the methods is described using aviation obstruction lights, it should not, in any manner, be construed to restrict the application of the solar based battery charging solely to such systems and/or devices. The solar based battery charging can be applied to all conventional battery enabled systems and particularly to systems that are positioned remotely or are susceptible to discontinuous power supply.

In view of the disadvantages inherent with the conventional aviation obstruction lights, the general purpose of the present invention is to provide a system and method for a solar powered aviation obstruction light in a cost effective, environment friendly and reliable manner.

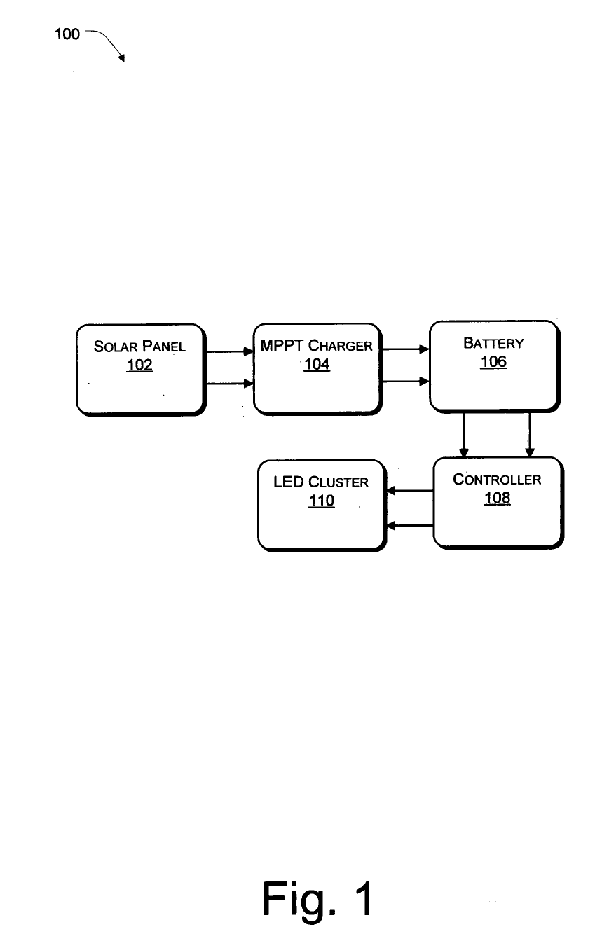

FIG. 1 illustrates a solar based battery charging system. To illustrate the working of the solar based battery charging system, its exemplary use in an aviation obstruction light 100 has been described. In an embodiment, the aviation obstruction light 100 comprises of a solar panel 102, a suitable/optimal battery charger like a maximum power point tracker (MPPT) 104, a battery system 106, a controller 108, and a LED cluster 110. In an embodiment, the solar panel 102 can be positioned exterior to the battery system 106 and the LED cluster 110 on a mounting arrangement where angle of the solar panel 102 to the horizontal can be changed as per user requirements. The solar panel 102 can be angled such that during the daytime, while charging, maximum amount of sunlight falls on the solar panel 102 for maximum time of the day.

In an embodiment, the battery system 106 can include one or more batteries configured to light the LED cluster 110 of the aviation obstruction light 100 during night or during periods of low light and/or visibility. In another embodiment, the batteries can have smaller AH rating having capability to handle the lighting requirement of the LED cluster 110 for at least one night. In an embodiment, the controller 108 senses the battery voltage of each battery in the battery system 106, preferably in the discharging mode in the morning, and indicates the solar panel 102 to start charging the battery having the highest voltage. The controller 108 can be assembled along with the battery system 106 to form a micro-controller based battery charging system 106. Charging the battery having highest remaining voltage ensures that at least one good battery in the battery system 106 is available at the earliest and can be used in the night. Solar panel 102 can be used for charging the batteries in the shortest possible time. In an embodiment, the solar panel 102 can charge the batteries of the battery system 106 using a higher efficiency Maximum Power Point Tracking (MPPT) charging system 104. The MPPT charging system 104 provides more current than the maximum current limit of the solar panel 102 thereby enabling faster charging of the batteries. Furthermore, as the AH rating of the one or more batteries in the battery system 106 is smaller, charging through the solar panel 102 is more effective and efficient. In another embodiment, the one or more batteries of the battery system 106 are arranged in parallel with each other. Each battery of the battery system can also have one or more batteries in series to form a battery bank. In an embodiment, once the battery with the highest remaining voltage is fully charged, the solar panel 102 would then put the fully charged battery under trickle charge and start charging the next battery and so on. In another embodiment, the solar panel 102 can be provided with a plurality of slotted holes allowing rotation of the solar panel 102 to the appropriate direction and latitude giving the desired level of sunlight. In yet another embodiment, the battery system 106 includes multiple batteries charged simultaneously till each achieves a voltage level sufficient to protect them from going into a deep discharge condition in the standby mode and thereafter charging them one at a time till they are fully charged and switched to trickle charge mode so as to increase the overall life of the battery system 106.

In another embodiment, when the LED cluster 110 of the aviation obstruction light 100 is to be switched on during the night or during low light and/or visibility period, the controller 108 can indicate discharging of such battery of the battery system 106, which has the maximum charge as estimated when the battery was being charged by the solar panel 102. In an embodiment, the solar panel 102 can be used as a photo sensor to detect the day and/or night thereby assisting in signaling the LED cluster 110 to be switched on during the night or during periods of low light and/or visibility. In an embodiment, the controller 108 can also ensure rotation of the batteries for charging and/or discharging so that as far as possible, all the batteries of the battery system 106 are used one night at a time. This helps reduce the number of cycles a battery goes through, increasing the total life span of the battery system 106 and decreasing the maintenance required.

In another embodiment, in case battery fails and/or starts malfunctioning, the controller 108 can sense partial failure of the battery and send communication and/or signal calling for preventive maintenance well in time thereby preventing complete failure of the aviation obstruction light 100. Such communication can be sent through means such as SMS, which are well known in the art or through other means wired or RF as may be convenient to the user/customer. Partial failure of a battery can also enable self diagnostic measures to be run on the system and failures to be reported, ahead of total break down.

In yet another embodiment, in case the weather conditions do not permit solar charging, provision can also be made for external charging of the batteries of the battery system 106 with another battery and/or power source. In another embodiment, wind power can also be utilized for charging the batteries of the battery system 106 and can be utilized anytime during the day or night to charge one or more batteries. For example, while a battery is being charged with the solar panel 102, another battery of the battery system 106 can be charged along using the wind power. The controller 108 can also work directly with the wind power generation mechanism to ensure that charging signals are timely given to the wind power generator to charge the batteries of the battery system 106.

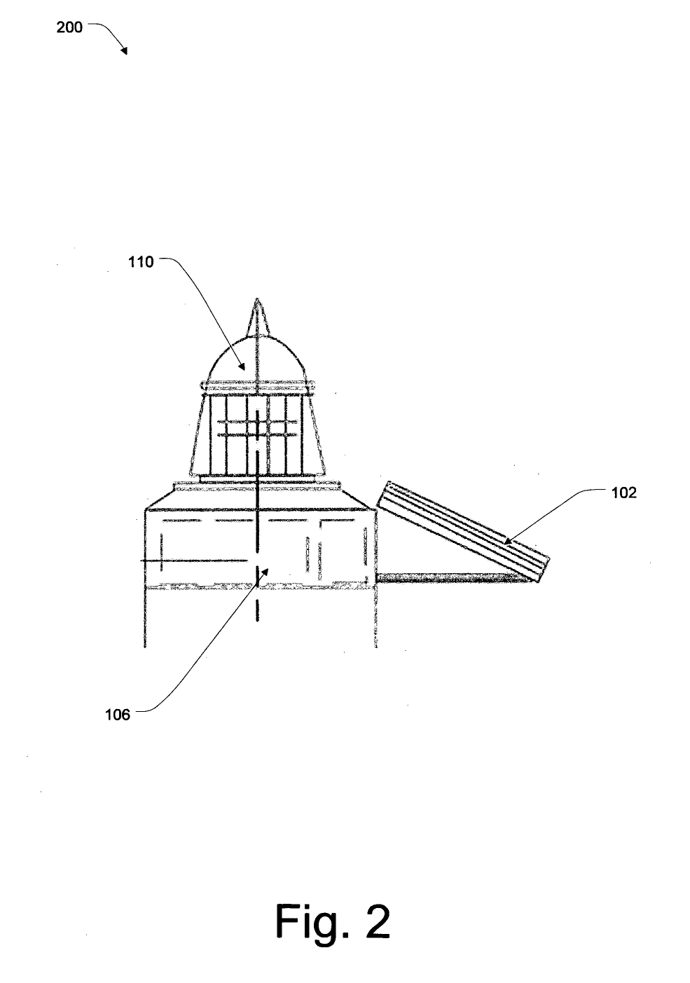

FIG. 2 illustrates structural layout 200 of a solar based battery charging system. To illustrate the working of the solar based battery charging system, its exemplary use in an aviation obstruction light 100 has been described. The structural layout 200 demonstrates the solar panel 102, the battery system 106, and the LED cluster 110. In an embodiment, the solar panel 102 energizes the batteries of the battery system 106, wherein the battery to be selected for charging is selected based on the indication given by the controller 108, which is further based on the battery having the highest remaining voltage level. In an embodiment, among the fully charged batteries by the solar panel 106 the battery having gone though the least number of discharge cycles is used first for lighting the LED cluster 110 during the night or during periods with low light and/or visibility and other batteries are sequentially used.

### EXEMPLARY METHODS

Exemplary method for implementing a solar based battery charging system is described with reference to FIGS. 1-2. These exemplary methods can be described in the general context of computer executable instructions. Generally, computer executable instructions can include routines, programs, objects, components, data structures, procedures, modules, functions, and the like that perform particular functions or implement particular abstract data types. The methods can also be practiced in a distributed computing environment where functions are performed by remote processing devices that are linked through a communication network. In a distributed computing environment, computer executable instructions may be located both in local and remote computer storage media, including memory storage devices.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual blocks may be deleted from the methods without departing from the spirit and scope of the subject matter described herein. In the context of software, the blocks represent computer instructions that, when executed by one or more processors, perform the recited operations.

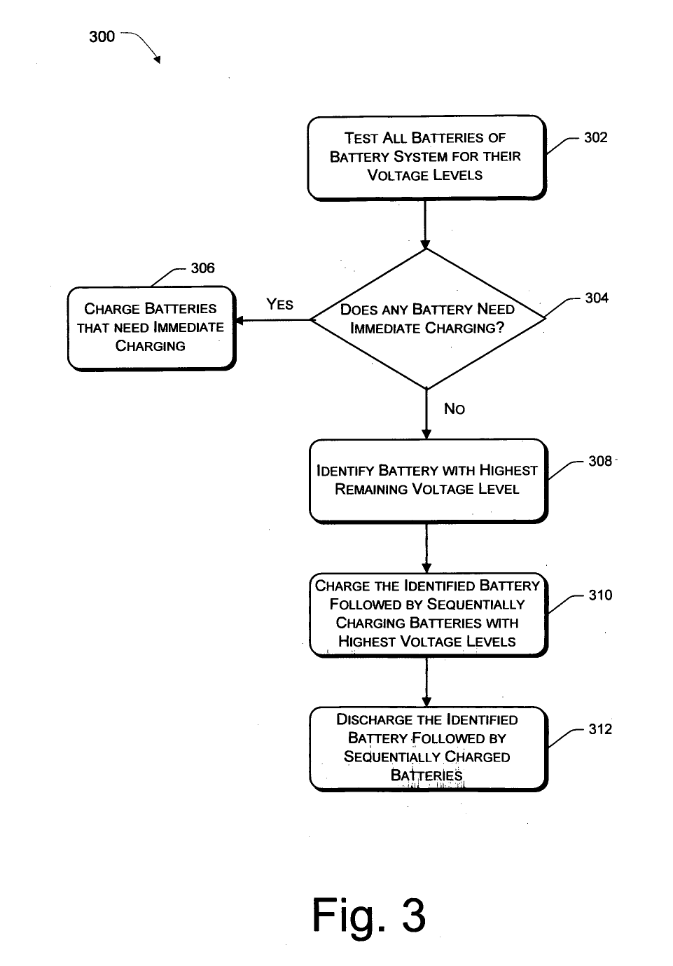

FIG. 3 illustrates an exemplary method 300 showing working of the solar based battery charging.

At block 302, voltage levels of one or more batteries of a battery system are tested by a controller. The controller typically tests the voltage level of the batteries during the morning time before the solar panel is used for charging such batteries.

At block 304, the controller evaluates as to whether any battery of the battery system requires immediate charging to prevent the battery from deep discharging or non-functioning. At block 306, in case any battery requires immediate charging, such battery or batteries, are immediately charged using the solar panel.

At block 308, in case none of the batteries need immediate charging, the controller identifies a battery, from the batteries of the battery set, with highest remaining voltage. At block 310, the identified battery is charged by the solar panel. The solar panel then, based on the solar energy available, sequentially charges the batteries with highest remaining voltage levels.

At block 312, the battery charged first is discharged first, typically during the night for use in aviation obstruction lights. Other batteries can be used for discharging, if needed, in their respective sequence of charging, with batteries that are charged first, being discharged first. If more than one battery is fully charged, the battery to be discharged shall be the battery which has been used/discharged the least.

These together with other aspects of the present invention, along with the various features of novelty that characterize the invention, are pointed out with particularity in the complete specification which will form a part of this disclosure. Although, the present invention is described in connection with exemplary embodiments, the invention is not intended to be limited to the specific forms set forth herein. On the contrary, it is intended to cover such alternatives, modifications, and equivalents as can be reasonably included within the scope of the invention.

### ADVANTAGES OF THE INVENTION

The invention provides solar based battery charging that allows reduction in solar panel size and further ensures charging of at least one battery, of a battery system having a plurality of batteries, in the shortest possible period.

The invention provides solar based battery charging for use in systems positioned remotely or susceptible to discontinuous power supply such as aviation obstruction lights.

The invention provides solar based battery charging that ensures optimal battery working even during periods of low sun intensity or during periods when sun is available intermittently or for a short period

The invention provides solar based battery charging for use in systems positioned remotely or susceptible to discontinuous power supply, which are cost effective and environment friendly

The invention provides solar based battery charging for use in systems with self-diagnostic features configured to effectively communicate partial failure of such systems.

The invention provides solar based battery charging that enables an efficient use of battery system thereby increasing its availability and working life.

The invention provides solar based battery charging for use in systems that enable saving of length/cost of the wires used to electrify the conventional systems.

The invention provides solar based battery charging for use in systems that enable saving the regular labor and maintenance expenses during and after installation of the system.

### CONCLUSION

Although the invention has been described in a language specific to structural features and/or methodological acts for providing a solar based battery charging mechanism, it is to be understood that the invention is not necessarily limited to the specific features or acts described. Rather, the specific features and acts are disclosed as exemplary forms of implementing the invention.

1. A solar based battery charging system comprising,
a battery system configured to power a device, wherein said battery system comprises of a plurality of batteries;
a solar panel configured to charge said plurality of batteries of said battery system; and
a controller operatively connected to said battery system and said solar panel, wherein said controller indicates at least one battery from said plurality of batteries to be charged by said solar panel, further wherein said at least one battery is indicated by said controller based on battery voltage levels of said plurality of batteries.

2. The solar based battery charging system as claimed in claim 1, wherein said controller sequentially indicates said at least one battery such that battery having highest remaining voltage level is charged first.

3. The solar based battery charging system as claimed in claim 2, wherein said plurality of batteries are discharged while powering said device based on one or more of sequence of charging of said plurality of batteries, number of charge discharge cycles that each of said plurality of batteries has gone through, and remaining life of each of said plurality of batteries.

4. The solar based battery charging system as claimed in claim 1, wherein said controller indicates said at least one battery for charging or discharging such that none of said plurality of batteries of said battery system becomes non-functional due to non-charging.

5. The solar based battery charging system as claimed in claim 1, wherein said plurality of batteries are connected in parallel, further wherein one or more of said plurality of batteries connected in parallel have batteries connected in series to form a battery bank.

6. The solar based battery charging system as claimed in claim 1, wherein said device is a LED cluster.

7. The solar based battery charging system as claimed in claim 1, wherein said solar panel is configured to detect day and/or night to indicate powering of said device.

8. The solar based battery charging system as claimed in claim 1, wherein said solar panel is configured to detect day and/or night to indicate charging and discharging of said plurality of batteries.

9. The solar based battery charging system as claimed in claim 1, wherein said controller is configured to enable rotation of said plurality of batteries of said battery system for charging by said solar panel and for discharging by said device.

10. The solar based battery charging system as claimed in claim 1, wherein said solar panel charges said plurality of batteries through maximum power point tracking charging system.

11. The solar based battery charging system as claimed in claim 1, wherein said solar panel is positioned exterior to said battery system, further wherein said solar panel is adjusted based on an angle dependent on latitude and direction of sun.

12. The solar based battery charging system as claimed in claim 1, wherein said controller is configured to sense partial failure of said battery system and partial or complete failure of said device and communicate said sensed failure through one or more communicating mechanisms.

13. The solar based battery charging system as claimed in claim 1, wherein said battery system is charged using one or more of an external power supply, a plurality of other batteries, or other renewable power generation mechanisms.

14. A method of charging a battery system using a solar panel for use in devices positioned remotely or susceptible to discontinuous power supply comprising,
providing a controller for selecting at least one battery from a plurality of batteries of said battery system based on voltage levels of said plurality of batteries;
indicating said solar panel to charge said at least one battery followed by sequential charging of said remaining plurality of batteries based on voltage levels of said remaining plurality of batteries and further based on solar energy remaining in said solar panel;
discharging said plurality of batteries based on one or more of sequence of charging of said plurality of batteries, number of charge discharge cycles that each of said plurality of batteries has gone through, and remaining life of each of said plurality of batteries.

15. The method as claimed in claim 14, further comprising selecting said at least one battery for charging or discharging such that none of said plurality of batteries of said battery system becomes non-functional or goes into deep-discharge due to non-charging.

16. The method as claimed in claim 14, wherein said controller sequentially indicates said at least one battery for charging such that battery having highest remaining voltage level is charged first.
